(19) United States
(12) Patent Application Publication
(10) Pub. No.: US 2026/0028519 A1
(43) Pub. Date: Jan. 29, 2026

(54) TWO-DIMENSIONAL NANOMATERIALS FOR CO2 MINERALIZATION IN DOWNHOLE ENVIRONMENTS

(71) Applicant: Saudi Arabian Oil Company, Dhahran (SA)

(72) Inventors: Abdulaziz S. Al-Qasim, Dammam (SA); Yuguo Wang, Dhahran (SA)

(73) Assignee: Saudi Arabian Oil Company, Dhahran (SA)

(21) Appl. No.: 18/786,634

(22) Filed: Jul. 29, 2024

(51) Int. Cl. C09K 8/06; C01B 32/60

(52) U.S. Cl. CPC C09K 8/06; C01B 32/60; C09K 2208/10

(57) ABSTRACT

A method of carbon dioxide mineralization includes dissolving minerals in a downhole environment; introducing into the downhole environment a dispersion of aqueous solution capsules in a medium of critical or supercritical carbon dioxide, the aqueous solution capsules including an aqueous solution encapsulated by two-dimensional particles, where the aqueous solution does not include a surfactant; contacting the dispersion with minerals present in the downhole environment; and forming carbonates with the minerals and carbon dioxide in the downhole environment by a mineralization process.

### BACKGROUND

CO₂ mineralization is a process where CO₂ reacts with minerals in a formation to form stable carbonates. This process may be enhanced by the presence of certain 2D particles that may catalyze the mineralization process. The specific types of 2D particles chosen may depend on the mineralogy of the formation and the specific reactions that are being targeted. Despite the simplicity of the stoichiometric reactions describing the formation of Ca- or Mg-carbonates, complex chemo-morphological interactions may result in non-monotonic kinetics of carbonate nucleation and growth.

CO₂ emulsions including 2D particles as described herein may be particularly useful in addressing these challenges. The 2D particles in the emulsions may serve as catalysts to enhance the CO₂ mineralization processes. Moreover, the emulsions may provide a medium for the safe and efficient transport of CO₂, thereby overcoming some of the infrastructure and handling challenges associated with this process. The specific compositions of these emulsions may be tailored to suit the specific requirements of the CO₂ mineralization applications, making the CO₂ emulsions a versatile and promising solution for carbon capture.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a method of carbon dioxide mineralization. The method may include dissolving minerals in a downhole environment; introducing into the downhole environment a dispersion of aqueous solution capsules in a medium of critical or supercritical carbon dioxide, the aqueous solution capsules including an aqueous solution encapsulated by two-dimensional particles, where the aqueous solution does not include a surfactant; contacting the dispersion with minerals present in the downhole environment; and forming carbonates with the minerals and carbon dioxide in the downhole environment by a mineralization process.

Other aspects and advantages of the claimed subject matter will be apparent from the following description and the appended claims.

### BRIEF DESCRIPTION OF DRAWINGS

FIG. 1 is a simplified schematic of an embodiment capsule useful for hydrogen storage in subsurface formations.

FIG. 2 is a simplified schematic of an embodiment dispersion in use in a subsurface formation.

FIG. 3 is a block flow diagram of an embodiment method of making a dispersion.

FIG. 4 is a simplified schematic of an embodiment subsurface formation.

FIG. 5 is a block flow diagram of an embodiment method of CO₂ mineralization.

### DETAILED DESCRIPTION

In one aspect, embodiments disclosed herein relate to compositions and methods for CO₂ mineralization in downhole environments. The compositions described herein include an aqueous solution encapsulated by effectively two-dimensional (2D) particles to critical or supercritical CO₂. In conventional CO₂/water emulsions, a surfactant must be used to stabilize the emulsion. The compositions and methods described herein do not require the use of a surfactant.

Some surfactants are known to be toxic, have negative environmental impacts, and have harmful effects on bodies of water. In addition, the production of surfactants may be costly, and some surfactants may be derived from nonrenewable resources. As such, the inclusion of surfactants in the compositions and methods described herein is not desired.

### Capsules of Aqueous Solution

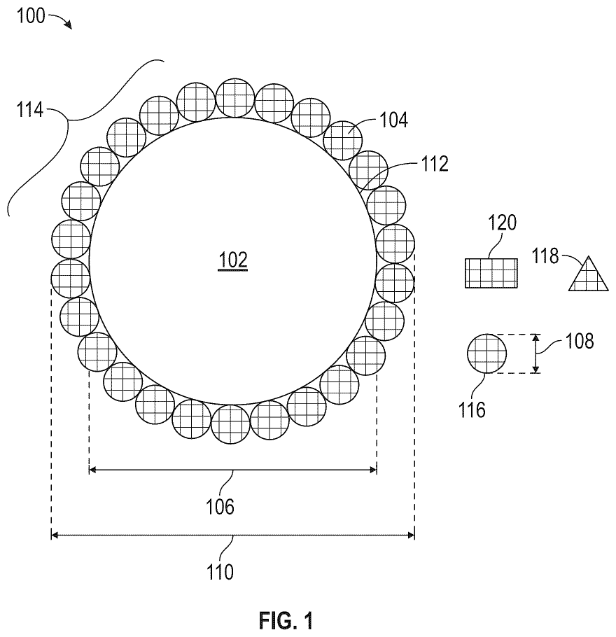

In one aspect, embodiment capsules disclosed relate to an aqueous solution encapsulated by two-dimensional (2D) particles. FIG. 1 shows a simplified schematic of an embodiment capsule useful for treating subterranean formations. FIG. 1 shows a capsule 100 having an aqueous solution 102 that is encapsulated by 2D particles 104. The aqueous solution 102 as given in capsule 100 has a solution diameter 106. The 2D particles 104 have a 2D particle diameter 108. The capsule 100 has a capsule diameter 110. In the embodiment shown in FIG. 1, the surface 112 of the aqueous solution 102 is surrounded by a layer of 2D particles 104 which form an encapsulating shell 114 around the aqueous solution 102 such that it is encapsulated. Several potential shapes of the 2D particles 104 are represented, such as circular 116, triangular 118, and square 120.

Embodiment capsules include an aqueous solution. For embodiment capsules, the aqueous solution includes water. The water may comprise one or more known compositions of water, including distilled; condensed; filtered or unfiltered fresh surface or subterranean waters, such as water sourced from lakes, rivers, or aquifers; mineral waters; gray water; run-off, storm or wastewater; potable or non-potable waters; brackish waters; synthetic or natural sea waters; synthetic or natural brines; formation waters; production water; and combinations thereof.

In some embodiments, the aqueous solution may also include one or more chemical additives. Embodiment chemical additives may include emulsifying agents, gelling agents, foaming agents, and surfactants.

In other embodiments, the aqueous solution may be free or substantially free of surfactants. “Substantially free” may refer to the aqueous solution including less than 1% or less than 0.05% by weight of surfactants. Capsules having an aqueous solution that is encapsulated by 2D particles as described herein do not require a surfactant as compared to CO₂/water emulsions known in the art. This may be due to the strong Van der Waals forces between the 2D particles and the CO₂, which may mitigate the polarity differences between CO₂ and water. This results in the ability of the 2D particles to stabilize the CO₂/water emulsion without the need of a surfactant.

In some embodiments, within the embodiment capsule the aqueous solution is in the form of a liquid, for example, a droplet or sphere. In such embodiments, the solution diameter may have a range of from about 10 nm (nanometers) to about 100 μm (micrometers), meaning the aqueous solution diameters have a D1 of about 10 nm and a D99 of about 100 μm. In some embodiments, the solution diameter may have a range of from about 10 nm to 200 nm. In other embodiments, the solution diameter may have a range of from about 10 μm to 100 μm. A D1 value means that 1% of the aqueous solutions have a diameter of less than the D1 value. A D99 value means that 99% of the aqueous solutions have a diameter of less than the D99 value.

Embodiment capsules also include a 2D particle. As described here, a 2D particle is a sheet of material that is effectively two dimensional, meaning the thickness of the particle is negligibly small. A “negligibly small” thickness refers to a thickness of not greater than 1 nanometer (nm). As is understood by those skilled in the art, such sheets may only be several atomic layers thick, and may therefore have a minimum thickness of 1, 2, or 3 Angstroms. As such, the 2D particles generally have a length and width of at least 10 nanometers, and a maximum thickness of about one nanometer. For example, the 2D particles may have a thickness equal to or less than 1 nm. In one or more embodiments, the 2D particle is not greater than three atomic layers in thickness. Examples of shapes of the 2D particle may include, but are not limited to, nanosheets, nanoflakes, and nanoplatelets.

Embodiment capsules may include non-metallic materials, such as graphene, boron nitride, and phosphorene. In some embodiments, the 2D particle is graphene. Embodiment graphene may be made by suitable methods, such as chemical exfoliation, mechanical exfoliation, or liquid-phase exfoliation of graphite, chemical vapor deposition (CVD), and chemical reduction of graphene oxide. Embodiment graphene may have a hexagonal crystal structure. Embodiment graphene has a bulk density of from about 0.03 to about 1.0 g/cm² (grams per centimeter squared) and a skeletal density of about 2.267 g/cm².

In some embodiments, the 2D particle is boron nitride. In some embodiments, the boron nitride may have a hexagonal crystal structure and be referred to as hexagonal boron nitride (hereafter “h-BN”). Embodiment h-BN may be made by suitable methods, including mechanical exfoliation, CVD, liquid-phase exfoliation, and chemical conversion of graphene or boron nitride nanotubes. Embodiment h-BN has a bulk density of about 0.3 g/cm² and a skeletal density of about 2.25 g/cm².

Embodiment capsules may include metallic materials, such as transition metal dichalcogenides (TMD) and MXenes. In some embodiments, the 2D particle is a transition metal dichalcogenide (TMD). TMDs may be 2D particles with a formula of MX₂ where M is a transitional metal and X is a chalcogen. The metal may include Mo or W. The chalcogen may include S, Se, or Te. TMDs may have a sandwich structure, where a metal layer is enclosed by two chalcogen layers. TMDs may be made by suitable methods, such as mechanical exfoliation, CVD, liquid-phase exfoliation, hydrothermal synthesis, and electrochemical exfoliation. Example TMDs include, but are not limited to, molybdenum disulfide (MoS₂) and tungsten disulfide (WS₂).

In some embodiments, the 2D particle is a MXene. MXenes may be a 2D particle with a formula of Mₙ₊₁XₙTₓ where M is a transition metal (such as Ti or V); X is carbon or nitrogen; n is 1, 2 or 3; and Tₓ is a surface termination group (such as O, OH, or F). Embodiment MXenes may be made by suitable methods, such as selective etching of the “A” layers from MAX phase group ternary metal carbides or nitrides. MAX phase group ternary carbides or nitrides may be layered materials with a hexagonal crystal structure. MAX phase group ternary metal carbides or nitrides may have the formula Mₙ₊₁AXₙ where M is a transition metal; n is 1, 2, or 3; A is an A-group element (such as group IIIA or IVA of the Periodic Table); and X is a carbon or nitrogen. Example MXenes may include, but are not limited to, Ti₃C₂Tₓ and V₂CTₓ.

In some embodiments, the 2D particles may be functionalized with a metal. Example metals may include copper, nickel, iron, and combinations thereof. Functionalization of the 2D particles with a metal may improve the ability to catalyze the formation of carbonates with CO₂. Functionalization with metal may occur by depositing metal atoms on the surface of the 2D particle. Deposition may occur by methods such as chemical vapor deposition, sputtering, electrochemical deposition, or solvothermal synthesis.

On the macro-scale, embodiment 2D particles may be any appropriate shape useful for encapsulating aqueous solutions. For example, as shown in FIG. 1, 2D particles are shown as circular 116, square 120, and triangular 118; however, geometric and non-geometric configurations are not limited except as to provide for an encapsulating surface for the aqueous solution.

Embodiment 2D particles may be any appropriate size for encapsulating aqueous solutions. Based upon the configuration or geometry of the form of the 2D particle, the particle size may be determined by a center-traversing axis parallel with its longest length. So, for example, a circle may be measured by its diameter; a square by its diagonal. “Length” may then refer to the length of a diameter or a length of a diagonal. In some embodiments, the 2D particles have a length in a range of from about 10 to about 200 nm (nanometers), meaning the 2D particles have a D1 of about 10 nm and a D99 of about 200 nm. A D1 value means that 1% of the 2D particles have a diameter of less than the D1 value. A D99 value means that 99% of the particles have a diameter of less than the D99 value.

In some embodiments, the 2D particles are hydrophobic. In such embodiments, the water contact angle of embodiment 2D particles is from about 90° to about 180°. In some embodiments, the water contact angle of embodiment 2D particles is less than 120° or less than 150°. Embodiment graphene may have a water contact angle of from about 95° to 130°. Embodiment h-BN may have a water contact angle of up to 150°.

The 2D particles may be hydrophobic due to the presence of alkyl groups native to the 2D particles. The alkyl groups are nonpolar due to the similar electronegativity of carbon and hydrogen, and this nonpolarity results in the alkyl groups being hydrophobic. The 2D particles may be functionalized to further enhance the hydrophobicity or to introduce other desired properties. The methods of functionalization may include esterification, amidation, silyation, and urethanization methods to provide ester, amide, silyl and urethane groups on the surface, among others. Other desired properties include reduced aggregation in aqueous solutions, reactive sites for tunable surface chemistry, and enhanced stability in organic solvents or nonpolar environments.

Embodiment 2D particles may have an appropriate BET surface area for use in supercritical CO₂ (SCCO2) environments. As used here, “BET surface area” refers to the average surface area of the 2D particles as measured by the BET (Brunauer Emmet Teller) nitrogen absorption method according to ASTM D-6556. BET surface area is reported in meters squared per gram of material. As will be explained in greater detail, in embodiment dispersions, supercritical CO₂ adsorbs on the surface of hydrophobic 2D particles. By tuning the surface area of embodiment 2D particles, the amount of CO₂ adsorption to the surface of the 2D particles may be tuned. That is, increasing particle surface area may result in greater amounts of CO₂ being absorbed by the 2D particle, and vice versa. In turn, greater amounts of CO₂ concentrated in a smaller volume may result in a further densification of the bulk SCCO2 medium.

In some embodiments, the BET surface area of the 2D particles may be from about 2200 to about 2600 m²/g (meters squared per gram). In some embodiments, the BET surface area of embodiment 2D particles may have a lower limit of one of 2200, 2250, 2300, 2350 and 2400 m²/g, and an upper limit of one of 2450, 2500, 2550 and 2600 m²/g, where any lower limit may be paired with any mathematically compatible upper limit.

As described, embodiment capsules include an aqueous solution that is encapsulated by 2D particles. The aqueous solution is surrounded by the 2D particles and does not disperse into the medium hosting the capsules. In embodiment capsules, the aqueous solution and the 2D particles are as previously described.

In some embodiments, capsules have a capsule size range, which is effectively the diameter of the capsule, from about a few nanometers to a few millimeters. The capsule size range for a given embodiment capsule should be approximately the same in all directions of the roughly spherical shape; however, variations in configuration between a given 2D particle and another may provide some statistically insignificant differences in determined capsule size range based on one diameter versus another. In such embodiments, the capsule diameter may have a range of from about 10 nm (nanometers) to about 100 μm (micrometers), meaning the capsules have a D1 of about 10 nm and a D99 of about 100 μm. In some embodiments, the capsule diameter may have a range of from about 10 nm to 200 nm. In other embodiments, the capsule diameter may have a range of from about 10 μm to 100 μm.

Embodiment capsules have a density in a range from about 0.9 to 1.2 g/mL (grams per milliliter).

### Dispersion of Capsules in Super/Critical Co2

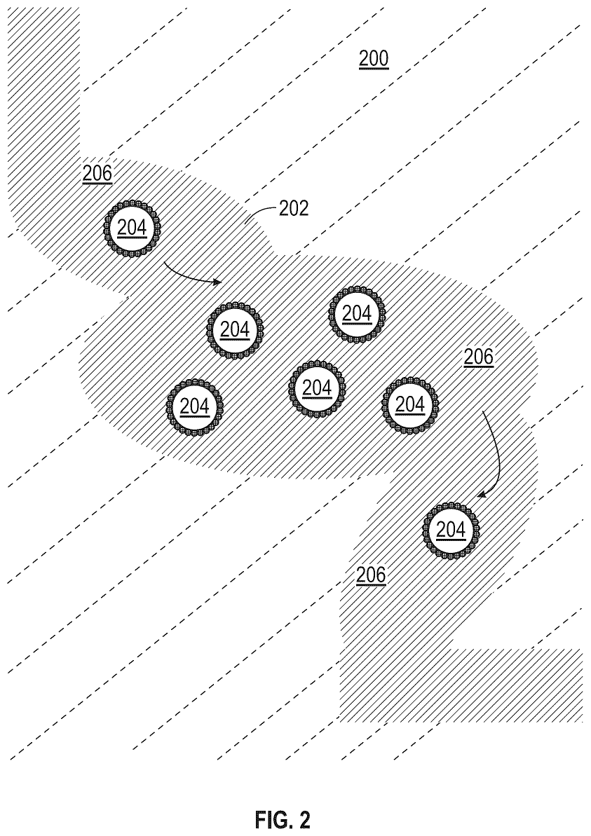

In another aspect, embodiments disclosed relate to a dispersion of the embodiment capsules previously described. FIG. 2 shows a simplified schematic of an embodiment dispersion in use in a hydrocarbon-bearing formation. A hydrocarbon-bearing formation 200 has pores 206 throughout. An embodiment dispersion within pores 206 may include carbon dioxide (CO₂) either at the critical state or in a supercritical state (referred to collectively as “SCCO2”) 202 and capsules 204. Arrows (not labeled) show the direction of flow of the embodiment dispersion through the hydrocarbon-bearing formation.

In embodiment dispersions, a medium of carbon dioxide that is at the critical state or in a supercritical state suspends the prior-discussed embodiment capsules. The critical temperature for carbon dioxide is approximately 31.1° C.; the critical pressure is approximately 8.38 MPa (megapascals). In some embodiment dispersions, the carbon dioxide is in a critical state. In some other embodiment dispersions, the carbon dioxide is in a supercritical state. Embodiment dispersions may include SCCO2 in a temperature range of from about 50° C. to about 100° C. Embodiment dispersions may include SCCO2 in a pressure range of from about 1500 psi (pounds per square inch) to about 5000 psi.

In some embodiment dispersions, the carbon dioxide medium may have a purity of at or greater than 90%. The purity of the carbon dioxide is determined before introduction of the capsules into the embodiment dispersion, the introduction of water into the carbon dioxide, or the introduction of the carbon dioxide into a subterranean formation, as any contact may introduce external impurities into the critical or supercritical carbon dioxide. In some embodiment dispersions, the carbon dioxide medium may have a density in a range of from about 0.8 to 0.9 g/mL.

Embodiment dispersions also include capsules as previously described. The capsules are stable in the critical and supercritical CO₂ environment. The 2D particle and aqueous solution do not physically or chemically degrade or disassociate due to the presence of the critical or supercritical CO₂.

Embodiment dispersions may include a percent volume of water as compared to the total volume of water and SCCO2. Embodiment dispersions may include from about 60 to 70 vol. % (volume percent) of water. A higher water content contributes to an increased density of embodiment dispersions, as water has a greater density than SCCO2 under formation conditions.

Embodiment dispersions may include any suitable amount of 2D particles. In some embodiments, dispersions may include up to 5.0 wt. % of 2D particles in terms of the total weight of the dispersion. Embodiment dispersions may have a lower limit of about 1.0, 1.5, 2.0, or 2.5 wt. % 2D particles, and an upper limit of about 5.0, 4.5, 4.0, 3.5, or 3.0 wt. % 2D particles, where any lower limit may be used in combination with any mathematically compatible upper limit.

Embodiments dispersions may have a pH ranging from about 8 to about 12. For example, the dispersion may have a pH with a lower limit of one of any of 8, 9, and 10, with an upper limit of one of any of 10, 11, and 12, where any lower limit may be combined with any mathematically compatible upper limit. pH of the dispersion may be adjusted by adding a base. The base may be sodium hydroxide. For example, a 0.01 M solution of sodium hydroxide may be added until the desired pH is reached.

Embodiment dispersions may have a bulk density suitable for mitigating gravity override. Such dispersions may have a bulk density of from about 0.9 to 1.2 g/mL at formation conditions. Embodiment dispersions may include a range from about 50 to 70 vol. % of embodiment capsules.

### Method of Forming a Dispersion

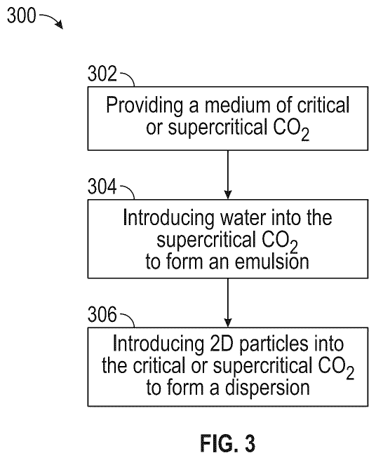

In another aspect, embodiments disclosed here relate to a method of making the previously described dispersion. FIG. 3 is a block flow diagram of an embodiment method 300 of making a dispersion.

The method 300 may include providing a medium of critical or supercritical carbon dioxide 302. In some embodiments, providing the medium may include introducing critical or supercritical carbon dioxide into a subterranean formation. In such cases, the dispersion may be formed in situ, that is, within the formation to be treated with the dispersion. As such, the treatment of the formation and the creation of the dispersion occur virtually simultaneously. In other embodiments, the dispersion is fabricated outside of a subterranean formation, such as on the surface or in a production facility and introduced through an injection well.

The method 300 may include introducing water into the critical or supercritical carbon dioxide such that an emulsion of water in CO₂ forms 304. Embodiment SCCO2 may be in a temperature in in a range of from about 50° C. to about 100° C. and a pressure in a range of from about 1500 psi to about 5000 psi when water is introduced. The water may be introduced to SCCO2 by any suitable means in which the previously described temperatures and pressures may be maintained. For example, the water may be introduced by a pump configured to introduce fluids at a temperature and pressure greater than the temperature and pressure of the SCCO2, such by using a high pressure syringe pump. The water/SCCO2 may then be mixed using vigorous stirring to form an emulsion. If 2D particles are already present in the CO₂ as a dispersion, then the 2D particles encapsulate the aqueous solution and the dispersion forms.

Upon introducing an aqueous solution into a SCCO2 medium, an emulsion of water droplets in SCCO2 may be formed. However, such emulsions may not be stable for extended periods because water and SCCO2 naturally separate due to differences in polarity of the two fluids.

The method 300 may include introducing 2D particles into the critical or supercritical carbon dioxide 306. The SCCO2 medium in embodiment dispersions may be in a temperature in a range of from about 50° C. to about 100° C. and a pressure in a range of from about 1500 psi to about 5000 psi when 2D particles are added. Embodiment 2D particles may be added to embodiment dispersions as a dry powder. Embodiment 2D particles may be added to the CO₂ medium under vigorous stirring to evenly disperse the 2D particles. The mixture may then be stirred for about 30 to 60 minutes to form the dispersion.

In some embodiments, the water is added to the SCCO2 prior to the addition of the 2D particles to the SCCO2. If water is present in the CO₂ medium and emulsified, the embodiment dispersion may immediately form. The 2D particles described previously may be provided to the emulsion to encapsulate the aqueous solution micro- or nano-bubbles present, thereby mitigating the polarity difference, stabilizing the aqueous solution in the SCCO2 medium, and forming the dispersion from the emulsion of water and CO₂. In some embodiments, the 2D particles are added to the SCCO2 prior to the addition of the water to the SCCO2. If the aqueous solution is not present in the CO₂ medium, then a dispersion of 2D particles in the critical or supercritical CO₂ is formed. In some embodiments, the water and 2D particles may be introduced to the SCCO2 medium simultaneously.

When introduced into an aqueous solution in SCCO2 emulsion, the hydrophobic particles, such as the previously described 2D particles, may collect at the interface between the aqueous solution and the SCCO2, if water is already present in the CO₂ medium. If water is not present, the 2D particles may be distributed evenly throughout the CO₂ medium until water is introduced. When the aqueous solution is introduced, the 2D particles aggregate on the surface of the aqueous solution even though they are hydrophobic. As the 2D particles collect at the aqueous/SCCO2 interface, the aqueous solution is encapsulated and stabilized in the SCCO2 medium, similar to what is shown in FIG. 1. This 2D particle layer serves to encapsulate the aqueous solution.

Due to the hydrophobic nature of the embodiments of the 2D particles, Van der Waals forces may be strong between the CO₂ molecules in the SCCO2 and surfaces of the 2D particles. This may have the effect of CO₂ molecules affiliating with or adsorbing onto surfaces of the 2D particles. As such, CO₂ molecules may pack more tightly near the surface of a capsule as compared to molecules in the bulk SCCO2 medium. This may result in an increased bulk density for the capsule/SCCO2 dispersion versus a simple water/SCCO2 emulsion without the 2D particles.

### Method of Co2 Mineralization

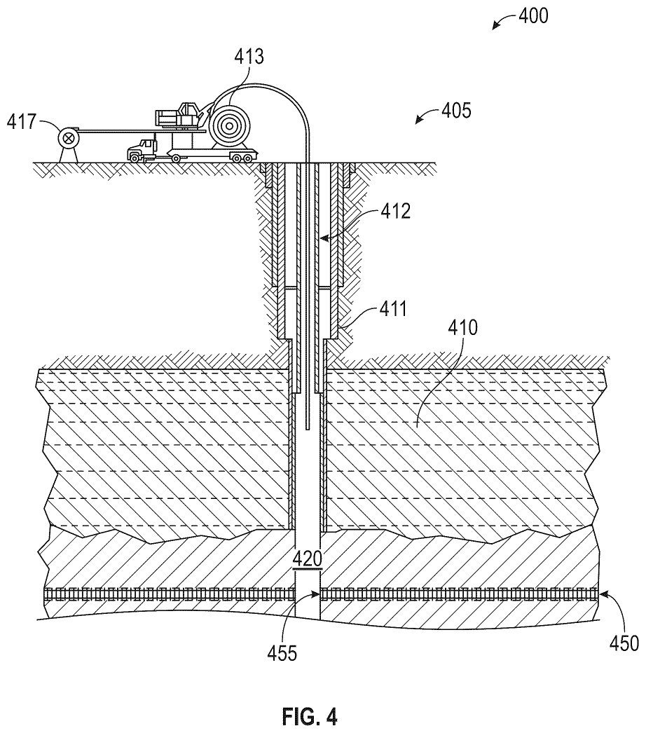

FIG. 4 is a diagram that illustrates a well environment 400 in accordance with one or more embodiments. Well environment 400 includes a subsurface 410. Subsurface 410 is depicted having a wellbore wall 411 both extending downhole from a surface 405 into the subsurface 410 and defining a wellbore 420. The subsurface 410 also includes target formation 450 to be treated. Target formation 450 has target formation face 455 that fluidly couples target formation 450 with wellbore 420 through wellbore wall 411. In this case, casing 412 and coiled tubing 413 extend downhole through the wellbore 420 into the subsurface 410 and towards target formation 450.

With the configuration in FIG. 4, the previously described embodiment dispersion that comprises the embodiment capsules in critical or supercritical carbon dioxide may be introduced into the subsurface 410 towards target formation 450 via a pump 417 through the coiled tubing 413. In another embodiment, as previously described, the dispersion may be formed in situ, meaning components of the dispersion (CO₂, aqueous solution, 2D particles) may be introduced into the subsurface 410 separately via the pump 417 through the coiled tubing 413, forming the dispersion inside the target formation 450. In such embodiments, multiple pumps may be used to separately inject components of the dispersion.

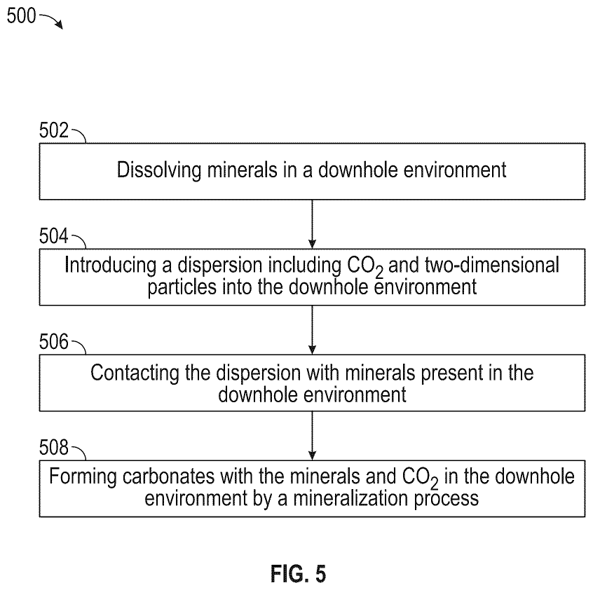

In one aspect, embodiments disclosed here relate to a method of using the previously described embodiment dispersion for CO₂ mineralization in a downhole environment. The dispersion may include 2D particles that act as a catalyst for CO₂ mineralization. The dispersion may be further modified based on the mineralogy of the subterranean formation and the subsequent specific mineralization reactions that are desired. Modifications to the dispersion may include modifying the temperature and pressure, high pressure homogenization, modifying the phases, ultrasonication, altering the pH, or modifying the ionic strength. Modifying the temperature and pressure conditions to near or beyond the critical point of CO₂ (as previously described) may influence the solubility and mixing properties, thus affecting the dispersion stability. Utilizing high-pressure homogenization techniques to create smaller and more uniform droplets may enhance the dispersion stability. Modifying the phases of the dispersion by manipulating the ratio of water to CO₂ may significantly affect the dispersion stability and properties. Applying ultrasonic energy to the dispersion may help in reducing the size of water droplets and in achieving a more stable and homogeneous dispersion. Altering the pH of the aqueous phase may influence the charge and thus impact the stability of the dispersion. Modifying the ionic strength of the aqueous phase through an addition of electrolytes may affect the electrostatic interactions between droplets, impacting stability. FIG. 5 is a block flow diagram of an embodiment method 500 of CO₂ mineralization.

The method 500 may include, at block 502, dissolving minerals present in a downhole environment. Dissolving may be done by introducing an acid into the downhole environment. For example, carbonic acid may be introduced to dissolve silicates present in the downhole environment. The carbonic acid (which dissociates into CO₂+H₂O) may react with the minerals and dissolve SiO₂, leaving metal cations free for mineralization with CO₂. This reaction is shown below.

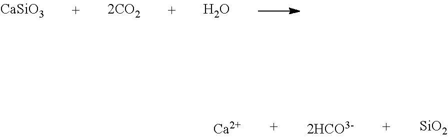 [SMILES: "CaSiO3" ; O ; "SiO2" ; [Ca+2]]

In another example, hydrochloric acid may react with minerals and dissolve Mg(OH)₂, leaving metal cations free for mineralization with CO₂. Carbonic acid may also react with minerals and dissolve Mg(OH)₂ as shown in the reaction below.

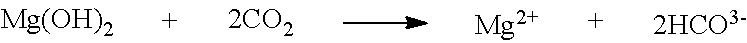

The choice of acid may depend on the conditions of the downhole environment (such as the downhole pressure and temperature) and the minerals present.

The method 500 may include, at block 504, introducing the previously described embodiment dispersion that includes the embodiment capsules in critical or supercritical carbon dioxide into a downhole environment. In some embodiments, the capsules in critical or supercritical carbon dioxide may be introduced into basaltic, peridotite, olivine, serpentine, or wollastonite formations. Requirements for a downhole environment to be suitable for CO₂ mineralization with the embodiment dispersion include available CO₂ dissolved in solution, available alkalinity in solution, chemical conditions that foster mineralization, biophysical site characteristics, and the availability of infrastructure and resources. For example, a higher pH may favor mineralization. As such, the embodiment dispersion may have a pH ranging from about 8 to about 12. Additionally, biophysical site characteristics such as size, injectivity, permeability, geomechanics, and microstructure may be considered when selecting a downhole environment for CO₂ mineralization.

Embodiment methods may include introducing a previously formed embodiment dispersion having the previously described embodiment capsules into a downhole environment. In other embodiments, components of the dispersion may be introduced separately, meaning that the CO₂, aqueous solution and 2D particles may each be introduced separately downhole, and embodiment dispersions may be formed in the downhole environment in situ. In embodiment dispersions, components may be added to the formation in any order, as previously described. If introduced downhole separately, the 2D particles may be suspended in a suitable solvent, such as oil or SCCO2. As such, in some embodiments, the dispersion is free or substantially free of surfactants. In other embodiments, the 2D particles may also be suspended in water provided it has surfactants to assist in suspension of the 2D particles.

The method 500 may include, at block 506, contacting the previously described embodiment dispersion that includes the embodiment capsules in critical or supercritical CO₂ with minerals present in the downhole environment. Minerals present in the downhole environment may include wollastonite (CaSiO₃), olivine (Mg₂SiO₄), pyroxenes (CaMgSi₂O₆), serpentine polytypes (Mg₃Si₂O₅(OH)₄), brucite (Mg(OH)₄), and combinations thereof. Contacting the dispersion with the minerals present in the downhole environment may initially require 2 to 48 hours. As used herein, initially refers to the initial phase of contacting in which the dispersion begins to react with the minerals. The contact between the minerals in the downhole environment and the dispersion may continue for up to two years.

The method 500 may include, at block 508, forming carbonates (—CO₃) with the minerals present in the downhole environment and CO₂ by a mineralization process. Forming carbonates by the mineralization process may depend on the minerals present in the downhole environment. Example mineralization processes may include processes shown in Reactions 1-5 below.

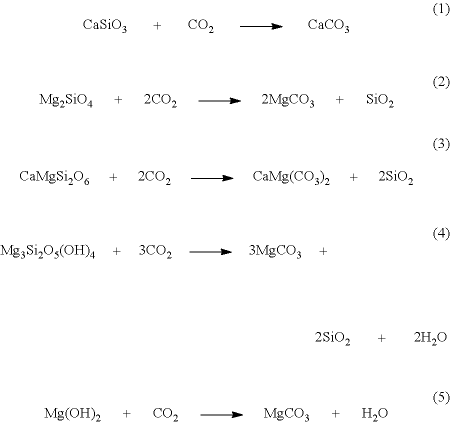

In one or more embodiments, the mineralization process is catalyzed by the 2D particles. In one or more embodiments, the 2D particles are functionalized with a metal. Example metals may include copper, nickel, iron, and combinations thereof. The metal on the 2D particles may serve as the catalyst for the mineralization process. The 2D particle may serve as a support for the metal.

Once the mineralization process is complete, carbonates may be formed. The carbonates and the dispersion may remain downhole. Keeping the carbonates downhole may serve as a method to capture CO₂ in a solid state. In one or more embodiments, CO₂ that was not consumed during the mineralization process may be recovered. The recovered CO₂ may be used again in the formation of the dispersion. The dispersion may be reintroduced downhole after a period of time. The period of time for reintroducing may range from a few months to up to two years.

Embodiments of the present disclosure may provide at least one of the following advantages. The compositions and methods described herein do not require the use of a surfactant. The dispersion as described herein provides an increased bulk density for the capsule/SCCO2 dispersion versus a simple water/SCCO2 emulsion without the 2D particles. Further, the 2D particles functionalized with metals as described herein may act as efficient catalysts for CO₂ mineralization.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed:

1. A method of carbon dioxide mineralization comprising:
dissolving minerals in a downhole environment;
introducing into the downhole environment a dispersion of aqueous solution capsules in a medium of critical or supercritical carbon dioxide, the aqueous solution capsules comprising an aqueous solution encapsulated by two-dimensional particles, where the aqueous solution does not comprise a surfactant;
contacting the dispersion with minerals present in the downhole environment; and
forming carbonates with the minerals and carbon dioxide in the downhole environment by a mineralization process.

2. The method of claim 1, wherein the two-dimensional particles have a length in a range of from about 10 to 200 nm and a width equal to or less than 1 nm.

3. The method of claim 1, wherein the two-dimensional particles are hydrophobic.

4. The method of claim 1, wherein the two-dimensional particles are selected from the group consisting of graphene, boron nitride, transition metal dichalcogenides, MXenes, and combinations thereof.

5. The method of claim 1, wherein the two-dimensional particles are functionalized with a metal.

6. The method of claim 5, wherein the metal is selected from the group consisting of copper, nickel, iron, and combinations thereof.

7. The method of claim 1, where the dispersion comprises in a range of from about 60 to 70 vol. % of the aqueous solution.

8. The method of claim 1, where the dispersion comprises up to 5.0 wt. % of the two-dimensional particles.

9. The method of claim 1, where the dispersion has a bulk density in a range of from about 0.9 to 1.2 g/mL.

10. The method of claim 1, wherein the downhole environment is selected from the group consisting of basaltic, peridotite, olivine, serpentine, or wollastonite formations.

11. The method of claim 1, wherein a pH of the dispersion is in a range of 8 to 12.

12. The method of claim 1, wherein the minerals are selected from the group consisting of wollastonite, olivine, pyroxenes, serpentine polytypes, brucite, and combinations thereof.

13. The method of claim 1, wherein contacting the dispersion with minerals present in the downhole environment initially occurs over a period of time ranging from 2 to 48 hours.
